(19) United States
(12) Patent Application Publication
(10) Pub. No.: US 2025/0220711 A1
(43) Pub. Date: Jul. 3, 2025

(54) Resource Allocation in Multi-Access Point Coordination

(71) Applicant: Cisco Technology, Inc., San Jose, CA (US)

(72) Inventors: Pascal Thubert, Roquefort-les-Pins (FR); Jerome Henry, Pittsboro, NC (US); JP Vasseur, Combloux (FR)

(21) Appl. No.: 18/806,586

(22) Filed: Aug. 15, 2024

Related U.S. Application Data
(60) Provisional application No. 63/615,214, filed on Dec. 27, 2023.

(51) Int. Cl. H04W 74/0816; H04W 74/04; H04W 74/08

(52) U.S. Cl. CPC H04W 74/0816; H04W 74/04; H04W 74/0866

(57) ABSTRACT

Devices, systems, methods, and processes for resource allocation among network devices are described herein. Access points (APs) with overlapping Radio-Frequency coverage may interfere with each other's transmission and reception operations. To address this, a device is provided with a bandwidth allocation logic that allocates resources among APs in a time and frequency domain. The device may determine a first transmission opportunity (TXOP) schedule and may obtain a second TXOP schedule associated with at least one network device. The device may determine whether there is any conflict between the first TXOP schedule and the second TXOP schedule. In case there is any conflict, the device may resolve the conflict and based on the resolution the network device may generate an aggregate TXOP schedule that may include proportions of resource units allocated to the device and the network device. The device may transmit the aggregate TXOP schedule to the network device.

The present disclosure relates to wireless networks. More particularly, the present disclosure relates to resource allocation among multiple access points in wireless networks.

This application claims the benefit of U.S. Provisional Patent Application No. 63/615,214, filed Dec. 27, 2023, which is incorporated by reference herein in its entirety.

### BACKGROUND

Wireless networks have become an integral part of modern communication systems, providing connectivity for a wide range of devices. A wireless network may include multiple access points that facilitate communication among network devices via radio frequency (RF) channels. Each network device may connect to a nearest access point in order to access the wireless network. Each access point along with a set of network devices associated therewith may form a basic service set (BSS). The set of network devices may use resources (for example, channel, spectrum, or the like) allocated to the corresponding access point.

Notably, each access point has a corresponding RF coverage area within which the corresponding set of network devices may connect to it. At times, the RF coverage areas of two or more access points may overlap, resulting in overlapping of BSSs. Overlapping BSSs may cause noise and interference for network devices associated with these access points. Such interference is often controlled by reducing the transmission power and reception sensitivity of overlapping access points.

Nevertheless, even with reduced transmission power and reception sensitivity, access points may still receive unwanted traffic and noise from neighboring network devices. Furthermore, such strategies may inadvertently compromise the quality of service provided. Therefore, such an approach may prove sub-optimal and lead to inefficient resource utilization.

### SUMMARY OF THE DISCLOSURE

Systems and methods for facilitating resource allocation in multi-access point coordination in accordance with embodiments of the disclosure are described herein. In some embodiments, a device includes a processor, a network interface controller configured to provide access to a network, and a memory communicatively coupled to the processor, wherein the memory includes a bandwidth allocation logic that is configured to: determine a first transmission opportunity (TXOP) schedule of the device, obtain a second TXOP schedule of at least one network device, generate an aggregate TXOP schedule based on the first TXOP schedule and the second TXOP schedule, wherein the aggregate TXOP schedule includes at least one TXOP that has a first proportion of resource units (RUs) allocated to the device and a second proportion of RUs allocated to the at least one network device, and transmit the aggregate TXOP schedule to the at least one network device.

In some embodiments, the bandwidth allocation logic is further configured to resolve at least one conflict between the first TXOP schedule and the second TXOP schedule.

In some embodiments, the aggregate TXOP schedule is generated in response to resolving the at least one conflict between the first TXOP schedule and the second TXOP schedule.

In some embodiments, the at least one conflict is caused by one or more overlapping RU requirements in the first TXOP schedule and the second TXOP schedule.

In some embodiments, obtaining the second TXOP schedule includes receiving the second TXOP schedule from the at least one network device.

In some embodiments, obtaining the second TXOP schedule includes predicting the second TXOP based on a set of rules.

In some embodiments, the bandwidth allocation logic is further configured to learn the set of rules based on one or more historical TXOP schedules of the at least one network device.

In some embodiments, the second TXOP schedule includes at least one of an uplink schedule or a downlink schedule.

In some embodiments, the second TXOP schedule includes at least one of a TXOP count, a transmission interval, a transmission duration, or an amount of traffic.

In some embodiments, in response to transmitting the aggregate TXOP schedule, the bandwidth allocation logic is further configured to receive a proposed aggregate TXOP schedule from the at least one network device.

In some embodiments, the proposed aggregate TXOP schedule includes at least a third proportion of RUs allocated to the at least one network device that is different from the second proportion of RUs.

In some embodiments, the first proportion of RUs and the second proportion of RUs are distributed in a time and frequency domain.

In some embodiments, the first TXOP schedule includes a first set of RU requirements associated with the device and the second TXOP schedule includes a second set of RU requirements associated with the at least one network device.

In some embodiments, the first set of RU requirements is represented in a first color in the first TXOP schedule and the second set of RU requirements is represented in a second color in the second TXOP schedule.

In some embodiments, the bandwidth allocation logic is further configured to assign one or more weights to the first set of RU requirements and the second set of RU requirements, and resolve at least one conflict between the first TXOP schedule and the second TXOP schedule based on the one or more weights, wherein the aggregate TXOP schedule is generated in response to resolving the at least one conflict.

In some embodiments, the aggregate TXOP schedule includes the first proportion of RUs represented in the first color and the second proportion of RUs represented in the second color.

In some embodiments, prior to generating the aggregate TXOP schedule, the bandwidth allocation logic is further configured to establish Multi-Access Point (AP) coordination between the device and the at least one network device.

In some embodiments, the second TXOP schedule is associated with a set of network devices coordinated by the at least one network device.

In some embodiments, a bandwidth allocation logic is configured to transmit a first TXOP schedule to a network device, wherein the network device is a designated coordinator for Multi-Access Point (AP) coordination and has a second TXOP schedule, and receive an aggregate TXOP schedule based on the first TXOP schedule and the second TXOP schedule, wherein the aggregate TXOP schedule includes at least one TXOP that has a first proportion of resource units (RUs) allocated to the device and a second proportion of RUs allocated to the network device.

In some embodiments, a method includes determining a first transmission opportunity (TXOP) schedule of a first network device, obtaining a second TXOP schedule of a second network device, generating an aggregate TXOP schedule based on the first TXOP schedule and the second TXOP schedule, wherein the aggregate TXOP schedule includes at least one TXOP that has a first proportion of resource units (RUs) allocated to the first network device and a second proportion of RUs allocated to the second network device, and transmitting the aggregate TXOP schedule to the second network device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a schematic diagram of an example network architecture in accordance with various embodiments of the disclosure;

FIG. 3 is a schematic diagram of another example network architecture in accordance with various embodiments of the disclosure;

FIG. 4 is a graphical representation that illustrates an example scenario of resource allocation by utilizing overlapping BSS coloring scheme in accordance with various embodiments of the disclosure;

FIG. 5 is a graphical representation that illustrates another example scenario of resource allocation by utilizing overlapping BSS coloring scheme in accordance with various embodiments of the disclosure;

FIG. 6 is a flowchart showing a process for RU allocation in accordance with various embodiments of the disclosure;

FIG. 7 is a flowchart showing a process for RU allocation in accordance with various embodiments of the disclosure;

FIG. 8 is a flowchart showing a process for obtaining RU allocation in accordance with various embodiments of the disclosure;

FIG. 9 is a flowchart showing a process for RU allocation in accordance with various embodiments of the disclosure; and

FIG. 10 is a conceptual block diagram of a device suitable for configuration with a power management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are described herein that can facilitate resource allocation in multi-access point coordination in a wireless network. In recent times, wireless network has become one of the most popular ways of providing connectivity to network devices. The wireless network may include multiple access points (APs) that facilitate connectivity to associated network devices via Radio Frequency (RF) channels. Each AP along with a set of associated network devices may form a basic service set (BSS). At times, RF coverage areas of two or more APs may overlap, causing corresponding BSSs to overlap. The overlapping of BSSs may introduce noise and interference among network devices, consequently diminishing the quality of service (QoS) of the wireless network.

In many embodiments, a first AP may be associated with a first set of network devices that collectively form a first BSS. Similarly, a second AP may be associated with a second set of network devices that collectively form a second BSS. An RF coverage area of the first BSS may overlap with an RF coverage area of the second BSS. In such a scenario, the first and second BSSs may form a multi-access point coordination (MAPC) set and one of the first AP and the second AP can be selected as a coordinator. For example, the first AP is selected as the coordinator. As the coordinator, the first AP may implement a bandwidth allocation logic to establish MAPC between the first AP and the second AP and execute one or more operations related to MAPC.

In several embodiments, the first AP may be configured to determine a first transmission opportunity (TXOP) schedule. The first TXOP schedule may outline an anticipated requirement of resource units (for example, time interval, frequency channels, or the like) for transmission and reception operations between the first AP and the first set of network devices associated with the first AP. The first AP may further obtain a second TXOP schedule associated with the second AP. The second TXOP schedule may outline an anticipated requirement of resource units for transmission and reception operations between the second AP and the second set of network devices associated with the second AP.

In a variety of embodiments, the first AP may communicate a nudge message to the second AP and in response may receive (e.g., obtain) the second TXOP schedule from the second AP. Alternatively or additionally, the first AP may periodically receive the second TXOP schedule from the second AP. In some embodiments, the first AP may obtain the second TXOP schedule based on prediction. In such embodiments, the first AP may predict the second TXOP based on a set of rules (e.g., rules learnt by a prediction model). The set of rules may be indicative of the requirement of the resource units by the second AP for performing the transmission and reception operations. The set of rules may be derived or learnt, for example, by the prediction model, from a plurality of historical TXOP schedules received from the second AP in the past.

In more embodiments, each of the first and second TXOP schedules may include a TXOP count, a transmission interval, a transmission duration, or an amount of traffic. The TXOP count may refer to a number of TXOPs a network node may be required for its transmission and receptions operations. A TXOP may be indicative a time slot for which a specific frequency bandwidth would be utilized for transmission and receptions operations. The transmission interval may refer to a time duration between two consecutive TXOPs of the network node. The transmission duration may refer to the time slot of each TXOP. The amount of traffic may refer to a number of data packets or frames to be transmitted or received by the network node during a given TXOP.

In several additional embodiments, the first AP may determine whether there is any conflict between the first and second TXOP schedules. A conflict between the first and second TXOP schedules may arise due to one or more overlapping demands of the resource units. For example, the first AP and the second AP may simultaneously require to perform transmission or reception operations. Therefore, the first AP and the second AP may have a simultaneous and overlapping requirement of the resource units. Hence, a conflict may arise. In a number of embodiments, if there is a conflict between the first and second TXOP schedules, the first AP may resolve the conflict. For example, in order to resolve conflicts, the first AP, as the coordinator, may assign weights to a first set of resource unit (RU) requirements in the first TXOP schedule and a second set of RU requirements in the second TXOP schedule. In case of an overlapping requirement, the first AP may assign an RU to an RU requirement with a higher weight. Based on the resolution of the conflicts, the first AP may generate an aggregate TXOP schedule. In the aggregate TXOP schedule, a first proportion of RUs is allocated to the first AP and a second proportion of RUs is allocated to the second AP for at least one TXOP. The first and second proportions of RUs are distributed in a time and frequency domain. Thus, at times, the first and second APs can communicate with corresponding set of network devices simultaneously by utilizing different frequency channels.

In a variety of embodiments, the first AP may transmit the aggregate TXOP schedule to the second AP. The aggregate TXOP schedule may be adhered to by the first AP and the second AP for executing corresponding transmission and reception operations. In various embodiments, the first AP may communicate a trigger frame to the second AP, indicating a start of a next TXOP associated with the aggregate TXOP schedule.

In yet more embodiments, in the aggregate TXOP schedule, the first proportion of RUs can be represented in a first color and the second proportion of RUs can be represented in a second color. Such difference of colors, when plotted on a resource grid, may allow for easy identification of allocation of RUs in the time and frequency domain.

In further embodiments, the first AP may receive a proposed aggregate TXOP schedule from the second AP. The proposed aggregate TXOP schedule may include a third proportion of RUs allocated to the second AP and a fourth proportion of RUs allocated to the first AP. The third proportion of RUs may be different from the second proportion of RUs. The fourth proportion of RUs can be the same or different from the first proportion of RUs. The difference may be in terms of additional RUs allocated to the second AP in time and frequency domain. Alternatively, or additionally, the difference can be in terms of time slots of allocation of RUs.

In still more embodiments, the first AP may accept the proposed aggregate TXOP schedule. Subsequently, the first set of devices may initiate communication with the first AP by utilizing the fourth proportion of RUs and the second set of devices may initiate communication with the second AP by utilizing the third proportion of RUs. In still yet more embodiments, the first AP may not accept the proposed aggregate TXOP schedule and may negotiate with the second AP by transmitting another aggregate TXOP.

In numerous embodiments, the first and second APs may form a first MAPC set with the first AP as the coordinator and there can be other MAPC sets in an RF range of the first MAPC set. For example, two or more MAPC sets can have overlapping channels in range of each other, each with its own MAPC coordinator. In numerous additional embodiments, a plurality of MAPC coordinators can elect one of them as an arbitrator to coordinate conflicting RU demands arising from APs in the different MAPC sets. Secondary APs (e.g., APs in each MAPC set that are not selected as MAPC coordinator) in each MAPC set may communicate TXOP schedules to their MAPC coordinator, which in turn may generate corresponding aggregate TXOP schedules. Each MAPC coordinator may then communicate the generated aggregate TXOP schedule to the MAPC arbitrator. The MAPC arbitrator may resolve conflicts in the aggregate TXOP schedules and accordingly allocate RUs to each MAPC set.

Thus, an AP (e.g., a coordinator in intra-MAPC scenario or an arbitrator in inter-MAPC scenario) that can perform dynamic allocation of RUs among APs with overlapping BSSs (OBSS) is provided. The dynamic allocation of the RUs is performed to ensure that allocated RUs remain exclusive and non-overlapping in the OBSS. The resource allocation takes into account TXOP schedules of each AP. Therefore, connectivity requirements of each AP are fulfilled. Further, the AP may also assign weight to RU requirements of each secondary AP and may allocate the RUs in accordance with an importance of the RU requirements. Therefore, essential or time-sensitive transmission/reception operations take priority over non-essential or non-time-sensitive transmission/reception operations. To summarize, the AP may perform optimal and efficient allocation of resources in the wireless network.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

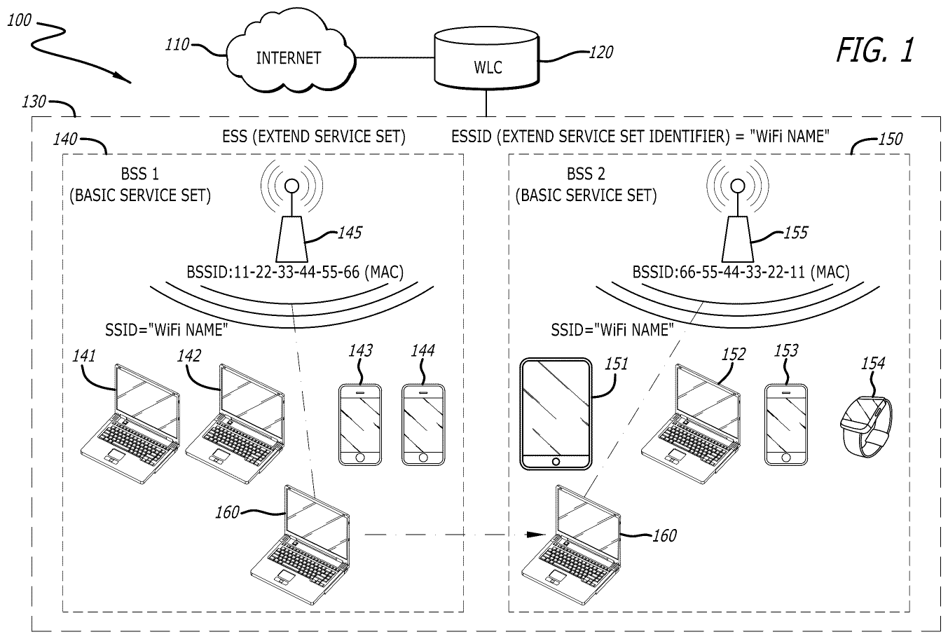

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, which is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It is important to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

The network can include a variety of user end devices that connect to the network. These devices can sometimes be referred to as stations (i.e., “STAs”). Each device is typically configured with a medium access control (“MAC”) address in accordance with the IEEE 802.11 standard. A physical layer can also be configured to communicate over the wireless medium. Various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “WiFi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

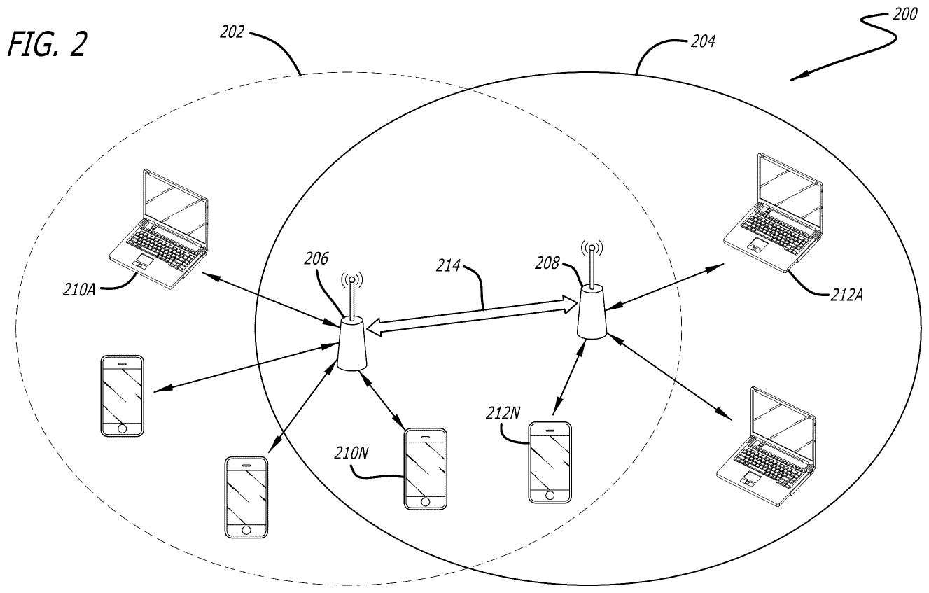

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-10 as required to realize a particularly desired embodiment.

Referring to FIG. 2, a schematic diagram of an example network architecture 200 in accordance with various embodiments of the disclosure is shown. The embodiments shown in FIG. 2 may illustrate a scenario where the network architecture 200 includes a first BSS 202 and a second BSS 204. The first BSS 202 may include a first AP 206 and a first plurality of network devices 210A-N and the second BSS 204 may include a second AP 208 and a second plurality of network devices 212A-N. An RF coverage area of the first AP 206 (e.g., shown by a dotted circle) and an RF coverage area of the second AP 208 (e.g., shown by a solid circle) may overlap, which may cause interference among the first plurality of network devices 210A-N and the second plurality of network devices 212A-N. For example, the first AP 206 and the second AP 208 can share the same primary-20 channel, which means the first AP 206 and the second AP 208 can use the same frequency for their main communication. In further example, the first AP 206 and the second AP 208 can have different primary-20 channels but overlap on secondary communication channels. In order to prevent interference, the first BSS 202 and the second BSS 204 may form a multi-access point coordination (MAPC) set.

An MAPC set may allow coordination among multiple APs within a wireless network for seamless connectivity, minimized interference, and maximized efficiency and performance of the wireless network. The coordination among the APs can be ensured based on communication of a requirement of network resources by each of the APs. The network resources are distributed in form of resource units (RUs) among the APs such that connectivity requirement of each AP is met.

The first AP 206 may be a network node that includes a processor and a network interface controller configured to provide access to a network (for example, a wireless network). The first AP 206 may further include a memory that may be coupled with the processor and may store a bandwidth allocation logic that may be executable by the processor. The first AP 206 may execute the bandwidth allocation logic to perform one or more operations for resource allocation within the MAPC set.

Likewise, the second AP 208 may be another network node that includes a processor and a network interface controller configured to provide access to the network (for example, a wireless network). The second AP 208 may further include a memory that may be coupled with the processor and may store the bandwidth allocation logic.

In a number of embodiments, the first AP 206 may be configured to establish an MAPC (indicated by arrow 214) between the first AP 206 and the second AP 208. To establish the MAPC, the first AP 206 may broadcast a discovery message to identify the second AP 208. Upon receiving a response from the second AP 208, one of the first AP 206 and the second AP 208 may be selected as a coordinator of the MAPC set. The selection of the coordinator may be pre-configured or dynamic. In an example scenario, upon discovery, the first AP 206 and the second AP 208 may broadcast status information, including parameters such as signal strength, current load, energy levels, computational resources, or the like. The shared status information may enable the first AP 206 and the second AP 208 to assess the overall network state. Based on one or more criteria (e.g., signal strength, load, energy reserves, and computational capability), each of the first AP 206 and the second AP 208 evaluates its suitability for coordinator role. For example, each of the first AP 206 and the second AP 208 may run a scoring algorithm and calculate scores for themselves and others. For example, if the first AP 206 has a stronger signal and lighter load than the second AP 208, the first AP 206 might score higher than the second AP 208. The first AP 206 and the second AP 208 may then broadcast the scores, and the AP with the highest score can be selected as the coordinator. For the sake of ongoing description and in a non-limiting example, the first AP 206 is assumed to be selected as the coordinator of the MAPC set.

In a variety of embodiments, the first AP 206, selected as the coordinator, may further establish synchronization protocols with the second AP 208, ensuring that both the first AP 206 and the second AP 208 operate in a coordinated manner. For establishing the synchronization protocols, the first AP 206 may generate a first transmission opportunity (TXOP) schedule. The first TXOP may include communication requirements of the first AP 206 and the first plurality of network devices 210A-N associated of the first AP 206. The first TXOP schedule may include a first set of RU requirements associated with the first AP 206.

In numerous embodiments, the first TXOP schedule may include a TXOP count, a transmission interval, a transmission duration, or an amount of traffic. In many examples, the TXOP count may refer to a total number of TXOPs that are granted to the first AP 206. In further examples, the TXOP count may be a current number of TXOP that has been utilized by the first AP 206. A TXOP may be indicative a time slot for which a specific frequency bandwidth would be utilized for transmission and receptions operations. The transmission interval may refer to a time duration between any two consecutive TXOPs in the first TXOP schedule. The transmission duration may refer to the time slot associated with each TXOP in the first TXOP schedule. The amount of traffic may refer to an anticipated count of data packets that would be transmitted or received by the first AP 206 during a corresponding TXOP in the first TXOP schedule. The amount of traffic can be expressed in unit of RUs, for each traffic identifier (TID). A TID may refer to a unique identifier associated with each stream of traffic within the network.

In more embodiments, the first TXOP schedule may include an uplink schedule for a future time interval. The uplink schedule may include a sequence, a routine, or a pattern of data packets to be transmitted by the first AP 206. In still more embodiments, the first TXOP schedule may include a downlink schedule for the future time interval. The downlink schedule may include a sequence, a routine, or a pattern of data packets to be received by the first AP 206.

In further embodiments, the second AP 208 may be configured to generate a second TXOP schedule after the selection of the first AP 206 as the coordinator. The second TXOP schedule may be generated by obtaining communication requirements (for example, transmission requirements or reception requirements) of each of the second plurality of network devices 212A-N. The second TXOP schedule may include an aggregated or collective connectivity requirements of the second AP 208 and the second plurality of network devices 212A-N. The second TXOP schedule may include a second set of RU requirements of the second AP 208 and the second plurality of network devices 212A-N. The second TXOP schedule may include a TXOP count, a transmission interval, a transmission duration, or an amount of traffic.

In some embodiments, the second TXOP schedule may include an uplink schedule for a future time interval. The uplink schedule may include a sequence, a routine, or a pattern of data packets to be transmitted by the second AP 208. In more embodiments, the second TXOP schedule may include a downlink schedule for the future time interval. The downlink schedule may include a sequence, a routine, or a pattern of data packets to be received by the second AP 208.

In further additional embodiments, the second AP 208 may be configured to transmit the second TXOP schedule to the first AP 206. For example, the second TXOP schedule may be broadcasted or unicasted to the first AP 206. The first AP 206 may obtain the second TXOP schedule. In several embodiments, the first AP 206 may receive the second TXOP schedule transmitted by the second AP 208. In several additional embodiments, the first AP 206 may obtain the second TXOP schedule based on prediction. For example, the second TXOP schedule may be obtained by predicting the connectivity requirements of the second AP 208. In such embodiments, the first AP 206 may predict the second TXOP schedule based on a set of rules. The set of rules may be learnt by identifying one or more patterns in historical TXOP schedules received from the second AP 208. In an example, a pattern in the historical TXOP schedule may indicate that the second AP 208 requires to transmit or receive a data packet after every “30 seconds”. Based on such a pattern, the first AP 206 may determine a rule that the second AP 208 requires an RU after every “30 seconds”. Based on such a rule, the first AP 206 may predict the second TXOP schedule that indicates a requirement of an RU after every “30 seconds”. In some examples, the first AP 206 may utilize one or more machine learning models to learn the set of rules from the historical TXOP schedules of the second AP 208.

In still further embodiments, the first AP 206 may be further configured to generate an aggregate TXOP schedule based on the first and second TXOP schedules. The aggregate TXOP schedule may be generated such that it meets the connectivity requirements of the first plurality of network devices 210A-N associated with the first AP 206 and the second plurality of network devices 212A-N associated with the second AP 208. The aggregate TXOP schedule may include a distribution of a set of RUs among the first AP 206 and the second AP 208. In other words, the aggregate TXOP schedule may include one or more TXOPs that have a first proportion of RUs allocated to the first AP 206 and a second proportion of RUs allocated to the second AP 208. The first proportion of RUs and the second proportion of RUs can be distributed in a time and frequency domain. The first proportion of RUs and the second proportion of RUs, collectively, form the set of RUs. Thus, as per resource allocation in the aggregate TXOP schedule, at times, the first AP 206 and the second AP 208 can communicate with corresponding set of network devices simultaneously by utilizing RUs distributed across frequency domain.

In still additional embodiments, the first TXOP schedule and the second TXOP schedule may have one or more conflicts. The conflicts in the first TXOP schedule and the second TXOP schedule may arise because of one or more overlapping RU requirements in the first and second sets of RU requirements. These conflicts can occur if the simultaneous RU demands of the first AP 206 and the second AP 208 exceed total available RUs that can be allocated to the first AP 206 and the second AP 208 in a given time duration. In such embodiments, the first AP 206 may be configured to resolve the conflicts prior to the generation of the aggregate TXOP schedule. The first AP 206 may be configured to associate a weight to each RU requirement in the first and second TXOP schedules. In case of a conflict, the first AP 206 may resolve the conflict by assigning an RU to an RU requirement with a higher weight. Subsequently, based on the resolution of the conflicts, the first AP 206 may be configured to generate the aggregate TXOP schedule.

In some more embodiments, the first TXOP schedule may include the first set of RU requirements represented in a first color and the second TXOP schedule may include the second set of RU requirements represented in a second color. In certain embodiments, the first set of RU requirements can be colored using the same base color (e.g., the first color) but with varying gradients, such as lighter and darker shades, indicating varying priorities or weights. Similarly, the second set of RU requirements can be colored using the same base color (e.g., the second color) but with varying gradients, such as lighter and darker shades, indicating the varying priorities or weights. Further, the aggregate TXOP schedule may include the first proportion of RUs represented in the first color and the second proportion of RUs represented in the second color. Such a representation of required and allocated RUs allows for an easy identification of resource requirements and allocated resources. Additionally, the first proportion of RUs can be colored using the same base color (e.g., the first color) but with varying gradients, such as lighter and darker shades, indicating the assigned weights. Similarly, the second proportion of RUs can be colored using the same base color (e.g., the second color) but with varying gradients, such as lighter and darker shades, indicating the assigned weights.

In numerous additional embodiments, the first AP 206 may be further configured to transmit the aggregate TXOP schedule to the second AP 208. The second AP 208 may accept the aggregate TXOP schedule in case the second proportion of RUs meet the second set of RU requirements associated with the second plurality of network devices 212A-N. Alternatively, if the aggregate TXOP schedule does not meet the second set of RU requirements, the second AP 208 may generate a proposed aggregate TXOP schedule. The proposed aggregate schedule may be generated as an alternative to the aggregate TXOP schedule. The proposed aggregate TXOP schedule may include a third proportion of RUs as an alternative to the second proportion of RUs. The third proportion of RUs may be different from the second proportion of RUs. In an example, in comparison to the second proportion of RUs, the third proportion of RUs may have a higher number of RUs allocated to the second AP 208. In more examples, in comparison to the second proportion of RUs, the third proportion of RUs may have RUs allocated to the second AP 208 at different time slots. In the proposed aggregate TXOP schedule, the third proportion of RUs may be allocated to the second AP 208. The proposed aggregate TXOP schedule may further include a fourth proportion of RUs as an alternative to the first proportion of RUs. In the proposed aggregate TXOP schedule, the fourth proportion of RUs may be allocated to the first AP 206. The second AP 208 may transmit the proposed aggregate TXOP schedule to the first AP 206.

In certain embodiments, the first AP 206 may accept the proposed aggregate TXOP schedule and may communicate a signal indicative of acceptance of the proposed aggregate TXOP schedule to the second AP 208. Subsequently, the first AP 206 may distribute the fourth proportion of RUs among the first plurality of network devices 210A-N to meet the connectivity requirements of the first plurality of network devices 210A-N. The second AP 208 may distribute the third proportion of RUs among the second plurality of network devices 212A-N to meet the connectivity requirements of the second plurality of network devices 212A-N.

In yet more embodiments, the first AP 206 may discard the proposed aggregation TXOP schedule. Subsequently, the first AP 206 may distribute the first proportion of RUs among the first plurality of network devices 210A-N to meet the connectivity requirements of the first plurality of network devices 210A-N. The second AP 208 may distribute the second proportion of RUs among the second plurality of network devices 212A-N to meet the connectivity requirements of the second plurality of network devices 212A-N.

In still yet more embodiments, the first AP 206 may communicate a signal indicative of a rejection of the proposed aggregate TXOP schedule to the second AP 208. Subsequently, the first AP 206 may distribute the first proportion of RUs among the first plurality of network devices 210A-N and the second AP 208 may distribute the second proportion of RUs among the second plurality of network devices 212A-N. In some examples, the first AP 206 may negotiate with the second AP 208 by transmitting a new aggregate TXOP schedule.

In various embodiment, in the aggregate TXOP, RUs can be allocated in a manner that allows the first AP 206 (e.g., the MAPC coordinator) and the second AP 308 (e.g., a secondary AP) to send aligned preambles and have different RUs allocated for data part of TXOP transmission.

In many further embodiments, the first AP 206 and the second AP 208 can be positioned in an environment where traffic pattern is structured. For example, the first AP 206 and the second AP 208 may be deployed in a factory, where traffic from each AP is expected to be known. In further examples, the first AP 206 and the second AP 208 may be deployed in an enterprise, where the first AP 206 is positioned closer to a cubicle island than the second AP 208 and expects the same type of traffic as the second AP 208 but with a larger volume. In such embodiments, RU sharing by way of the aggregate TXOP schedule can be coordinated by an administrator or negotiated statically between the first AP 206 and the second AP 208, where the second AP 208 can just report its traffic volume over the last interval instead of sharing anticipated TXOP schedule for next period.

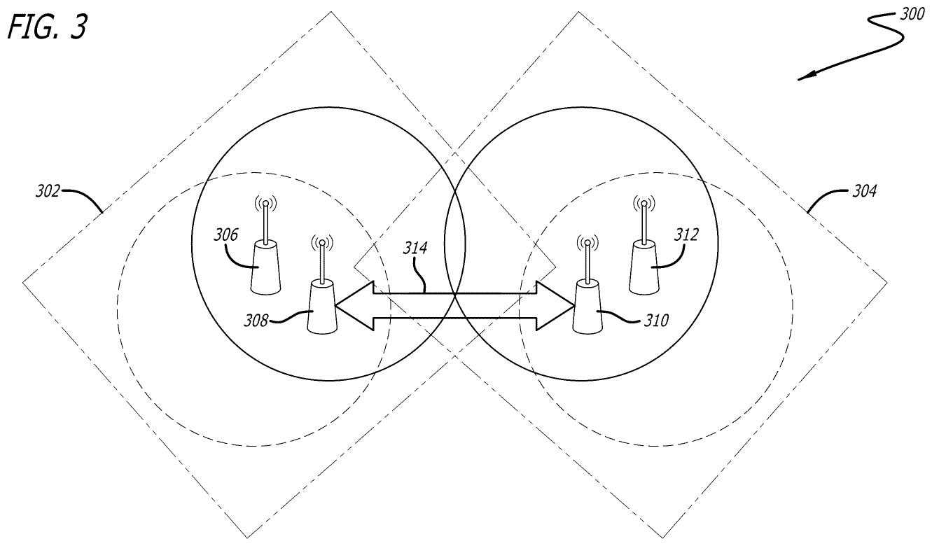

Though FIG. 2 describe MAPC coordination between two APs (the first AP 206 and the second AP 208), the scope of the disclosure is not limited to it. An MAPC set can include any number of APs without deviating from the scope of the disclosure. Further, it would be appreciated by a person skilled in the art that though FIG. 2 describes resource allocation within a single MAPC set, the scope of the disclosure is not limited to it. In several other embodiments, the resource allocation may be performed among multiple MAPC sets as described in conjunction with FIG. 3.

Although a specific embodiment for an example network architecture with intra-MAPC coordination in overlapping BSS scenario suitable for carrying out the various steps, processes, methods, and operations described herein is discussed with respect to FIG. 2, any of a variety of systems and/or processes may be utilized in accordance with embodiments of the disclosure. For example, instead of the first AP 206 acting as the MAPC coordinator, the MAPC coordinator role can be executed by a Wireless LAN Controller (WLC) coupled to the first AP 206 and the second AP 208. In such an embodiment, the first AP 206 and the second AP 208 may communicate their TXOP schedules to the WLC and the WLC may generate the aggregate TXOP schedule for the first AP 206 and the second AP 208. The elements depicted in FIG. 2 may also be interchangeable with other elements of FIGS. 1 and 3-10 as required to realize a particularly desired embodiment.

Referring to FIG. 3, a schematic diagram of another example network architecture 300 in accordance with various embodiments of the disclosure is shown. The embodiments shown in FIG. 3 may illustrate a scenario where the network architecture 300 includes a first MAPC set 302 and a second MAPC set 304. The first MAPC set 302 may include a first BSS having a first AP 306 and a second BSS having a second AP 308. In FIG. 3, the first BSS is shown by a dotted circle in the first MAPC set 302 and the second BSS is shown by a solid lined circle in the first MAPC set 302. The first AP 306 may be selected as a first coordinator of the first MAPC set 302. The second MAPC set 304 may include a third BSS having a third AP 310 and a fourth BSS having a fourth AP 312. In FIG. 3, the third BSS is shown by a dotted circle in the second MAPC set 304 and the fourth BSS is shown by a solid lined circle in the second MAPC set 304. The third AP 310 may be selected as a second coordinator of the second MAPC set 304.

In numerous embodiments, the first MAPC set 302 may be fall with an RF range of the second MAPC set 304. For example, the first MAPC set 302 can have overlapping channels with the second MAPC set 304. Thus, MAPC coordinators of the first MAPC set 302 and the second MAPC set 304 can select one of them as an arbitrator to coordinate conflicting inter-MAPC set RU demands. For example, one of the first AP 306 (coordinator of the first MAPC set 302) and the third AP 310 (coordinator of the second MAPC set 304) can be selected as the arbitrator.

In many embodiments, the first AP 306 may be selected as the arbitrator among the coordinators of the first MAPC set 302 and the second MAPC set 304. The selection of the arbitrator may be predefined or dynamic. For example, the selection of the arbitrator can be performed in a similar manner to the selection of the coordinator. The arbitrator may be responsible for allocating resources among the coordinators of a plurality of MAPC sets, for example, the first MAPC set 302 and the second MAPC set 304.

In a number of embodiments, the first AP 306 (e.g., the arbitrator) may receive TXOP schedules from a coordinator of each MAPC set in the network architecture 300. The TXOP schedule received from a coordinator of an MAPC set may be indicative of connectivity requirements of each AP in the MAPC set associated with the coordinator. In an example scenario, the first AP 306 may receive a first TXOP schedule from the third AP 310 which is the coordinator of the second MAPC set 304. The first TXOP schedule may be indicative of a first set of RU requirements associated with the third AP 310 and a second set of RU requirements of the fourth AP 312. As the coordinator of the first MAPC set 302, the first AP 306 may further receive a third set of RU requirements from the second AP 308. Based on the third set of RU requirements and a fourth set of RU requirements that may be associated with the first AP 306, the first AP 306 may generate a second TXOP schedule.

In a variety of embodiments, the first AP 306 may determine whether there is any conflict between the first and second TXOP schedules. The conflict may arise because of an overlapping requirement of RUs in the first and second TXOP schedules. In case of a conflict, the first AP 306 may resolve the conflict between the first and second TXOP schedules.

Based on the resolution of the conflict, the first AP 306 may generate an aggregate TXOP schedule that may include one or more TXOPs that have a first proportion of RUs allocated to the first AP 306 and a second proportion of RUs allocated to the third AP 310. As mentioned earlier, the first AP 306 is the coordinator of the first MAPC set 302 and the third AP 310 is the coordinator of the second MAPC set 304. Consequently, the first AP 306 may allocate RUs from the first proportion of RUs among the APs in the first MAPC set 302, for example, the first AP 306 and the second AP 308. Each of the first AP and the second AP 308 may distribute corresponding RUs among associated network devices in order meet connectivity requirements thereof. Similarly, the third AP 310 may allocate RUs from the second proportion of RUs among the APs in the second MAPC set 304, for example, the third AP 310 and the fourth AP 312. Each of the third AP 310 and the fourth AP 312 may distribute corresponding RUs among associated network devices in order meet connectivity requirements thereof. Upon allocation of the RUs, each network device in the first MAPC set 302 and the second MAPC set 304 may initiate communication by transmitting or receiving data packets or frames.

In an example scenario, the third AP 310 may receive the aggregate TXOP schedule from the MAPC arbitrator, for example, the first AP 306. The aggregate TXOP schedule may include a colored map of RUs as per the allocation. The aggregate TXOP schedule may outline the frequency/time slots allocated to the second MAPC set 304. The third AP 310 may then share the aggregate TXOP schedule with its secondary APs (e.g., the fourth AP 312), which may use the aggregate TXOP schedule as a guideline and attempt to adhere to it.

In numerous embodiments, the fourth AP 312 may also adjust its resource usage based on decisions of other coordinating APs (e.g., the first AP 306). For example, if the first AP 306 blocks the use of a specific RU/time slot, the fourth AP 312 can still utilize that specific RU/time slot by employing beamforming techniques, directing transmission signals away from the first AP 306 or the first MAPC set 302 to minimize interference. However, if the first AP 306 allows more spectrum space than initially allocated, the fourth AP 312 can take advantage of this additional space during beamforming, thereby optimizing resource usage.

In numerous additional embodiments, in order to ensure that such adjustments at secondary APs remain minimal and do not lead to significant interference with other APs, a heuristic or randomization method can be used. For example, the heuristic or randomization method can enable APs make informed decisions about which frequency/time slots to request in their TXOP schedules. For example, prior to sending the second aggregate TXOP schedule to the first AP 306, the third AP 310 may predict whether a requested RU in the second aggregate TXOP schedule will be granted, moved, or denied.

Although a specific embodiment for an example network architecture with inter-MAPC coordination in overlapping BSS scenario suitable for carrying out the various steps, processes, methods, and operations described herein is discussed with respect to FIG. 3, any of a variety of systems and/or processes may be utilized in accordance with embodiments of the disclosure. For example, instead of the first AP 306 acting as inter-MAPC arbitrator, the MAPC arbitrator role can be executed by a WLC. In such an embodiment, the first AP 306 and the third AP 310 may communicate their TXOP schedules to the WLC and the WLC may generate the aggregate TXOP schedule for the first MAPC set 302 and the second MAPC set 304. The elements depicted in FIG. 3 may also be interchangeable with other elements of FIGS. 1, 2, and 4-10 as required to realize a particularly desired embodiment.

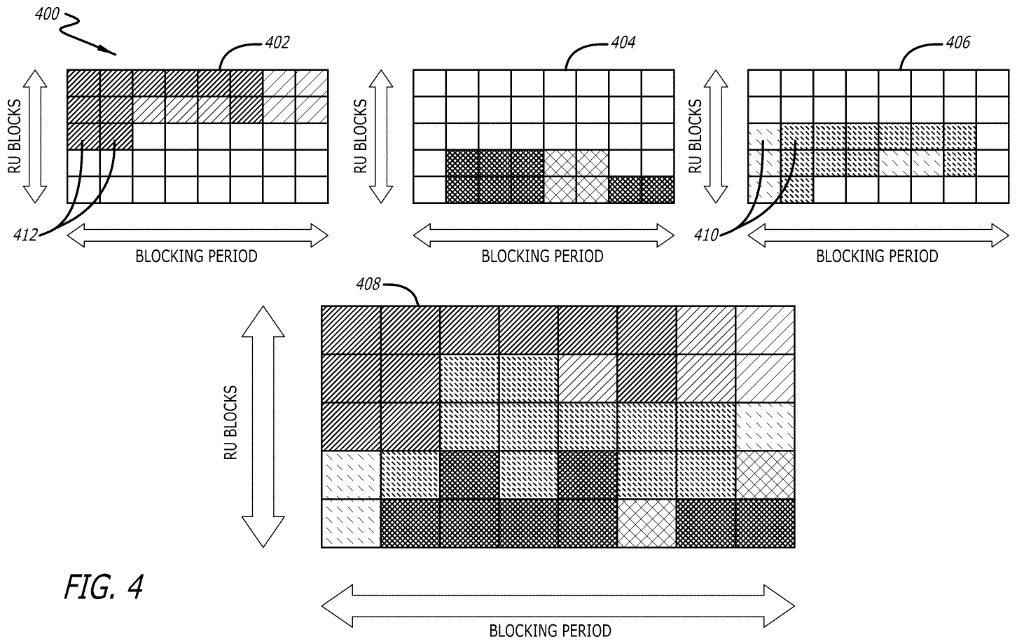

Referring to FIG. 4, a graphical representation that illustrates an example scenario 400 of resource allocation by utilizing overlapping BSS coloring scheme in accordance with various embodiments of the disclosure is shown. The embodiments shown in FIG. 4 may illustrate a first time-frequency graph 402, a second time-frequency graph 404, a third time-frequency graph 406, and a fourth time-frequency graph 408. The first time-frequency graph 402, the second time-frequency graph 404, the third time-frequency graph 406, and the fourth time-frequency graph 408 may represent a resource grid distributed across time and frequency domain. X-axis of the resource grid may represent a blocking period in time domain and y-axis may represent RU blocks in frequency domain. The blocking period may refer to slots of time during which RUs are allocated to an AP. An RU block may refer to a basic unit of frequency that may be allocated to an AP. For the sake of illustration, different colors are represented as unique patterns and color gradient is conveyed by varying degrees of shading within these patterns.

In many embodiments, the first time-frequency graph 402 may be associated with a first TXOP schedule of a first AP. The first TXOP schedule may include a first set of RU requirements associated with the first AP. The first set of RU requirements may be represented in a first pattern in the first time-frequency graph 402. The first set of RU requirements may include RU requirements with different priorities. A higher priority RU requirement is indicated by a darker shade of the first pattern. In other words, the first set of RU requirements can be colored using the same base color but with varying gradients, such as lighter and darker shades, indicating varying priorities. To summaries, the first TXOP schedule may include “11” high priority RU requirements, “4” medium priority RU requirements, and “4” low priority RU requirements, which are represented in the first time-frequency graph 402.

In further embodiments, the second time-frequency graph 404 be associated with a second TXOP schedule. The second TXOP schedule may be indicative of a second set of RU requirements associated with a second AP. The second set of RU requirements may be represented in a second pattern in the second time-frequency graph 404. The second set of RU requirements may include RU requirements with different priorities. A higher priority RU requirement is indicated by a darker shade of the second pattern. In other words, the second set of RU requirements can be colored using the same base color but with varying gradients, such as lighter and darker shades, indicating varying priorities. To summaries, the second TXOP schedule may include “8” high priority RU requirements and “4” low priority RU requirements, which are represented in the second time-frequency graph 404.

In a number of embodiments, the third time-frequency graph 406 may be associated with a third TXOP schedule. The third TXOP schedule may be indicative of a third set of RU requirements associated with a third AP. The third TXOP schedule may represent the third set of RU requirements in third pattern in the third time-frequency graph 406. The third set of RU requirements may include RU requirements with different priorities. A higher priority RU requirement is indicated by a darker shade of the third pattern. In other words, the third set of RU requirements can be colored using the same base color but with varying gradients, such as lighter and darker shades, indicating varying priorities. To summaries, the third TXOP schedule may include “11” high priority RU requirements and “5” low priority RU requirements, which are represented in the third time-frequency graph 406.

An MAPC coordinator may obtain the first time-frequency graph 402, the second time-frequency graph 404, and the third time-frequency graph 406. The MAPC coordinator may assess the first time-frequency graph 402, the second time-frequency graph 404, and the third time-frequency graph 406 to determine and resolve conflicts among the first through third TXOP schedules. For example, while assessing the first time-frequency graph 402 and the second time-frequency graph 404, the MAPC coordinator may determine that the first TXOP schedule and the second TXOP schedule do not have any overlapping cells. However, the MAPC coordinator may determine that two cells 410 in the third time-frequency graph 406 overlap with two cells 412 in the first time-frequency graph 402. Likewise, the MAPC coordinator may identify all cell overlaps among the first time-frequency graph 402, the second time-frequency graph 404, and the third time-frequency graph 406. Overlapping patterned cells in the first time-frequency graph 402, the second time-frequency graph 404, and the third time-frequency graph 406 may indicate conflict in RU requirements. The MAPC coordinator may resolve the conflicts among the first time-frequency graph 402, the second time-frequency graph 404, and the third time-frequency graph 406 and generate the fourth time-frequency graph 408. The fourth time-frequency graph 408 may represent an aggregate TXOP schedule.

In a variety of embodiments, the aggregate TXOP schedule may be generated based on the first, second, and third TXOP schedules. The aggregate TXOP schedule may include a first proportion of RU blocks represented in the first pattern, a second proportion of RU blocks represented in the second pattern, and a third proportion of RU blocks represented in the third pattern. As shown, the aggregate TXOP schedule may include “11” RU blocks allocated to high priority RU requirements, “3” RU blocks to medium priority RU requirements, and “2” RU blocks to low priority RU requirements, of the first AP. Further, the aggregate TXOP schedule may include “8” RU blocks allocated to high priority RU requirements and “2” RU blocks to low priority RU requirements, of the second AP. Additionally, the aggregate TXOP schedule may include “11” RU blocks allocated to high priority RU requirements and “3” RU blocks to low priority RU requirements, of the third AP. Therefore, each high priority RU requirement of the first, second, and third APs may be met by reorganizing the allocation of the RU blocks. Also, for accommodating the high priority RU requirements, “1” medium priority RU requirement of the first AP, “2” low priority RU requirements of the second AP, and “2” low priority RU requirements of the third AP, may not be allocated in a current TXOP. Such unmet RU requirements may be met in a subsequent TXOP schedule.

Although a specific embodiment for resource allocation by utilizing overlapping BSS coloring scheme suitable for carrying out the various steps, processes, methods, and operations described herein is discussed with respect to FIG. 4, any of a variety of systems and/or processes may be utilized in accordance with embodiments of the disclosure. For example, an MAPC arbitrator can also utilize the above described approach to allocate resources in inter-MAPC scenario. The elements depicted in FIG. 4 may also be interchangeable with other elements of FIGS. 1-3 and 5-10 as required to realize a particularly desired embodiment.

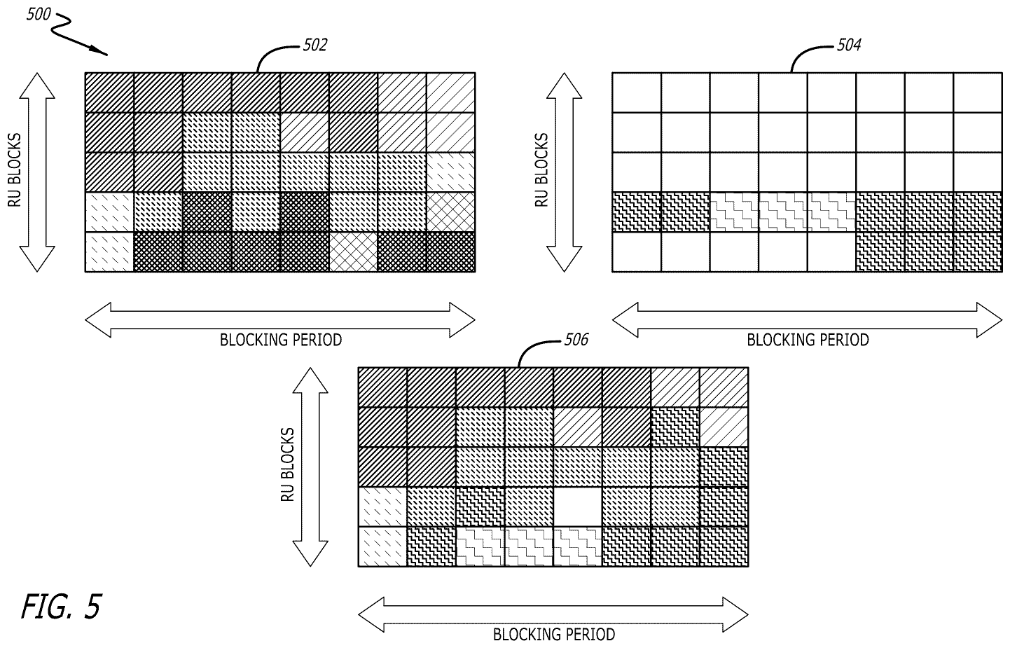

Referring to FIG. 5, a graphical representation that illustrates another example scenario 500 of resource allocation by utilizing overlapping BSS coloring scheme in accordance with various embodiments of the disclosure is shown. The embodiments shown in FIG. 5 may illustrate a first time-frequency graph 502, a second time-frequency graph 504, and a third time-frequency graph 506. The first time-frequency graph 502, the second time-frequency graph 504, and the third time-frequency graph 506 may represent a resource grid distributed across time and frequency domain. X-axis of the resource grid may represent a blocking period in time domain and y-axis may represent RU blocks in frequency domain. The blocking period may refer to slots of time during which RUs are allocated to an AP. An RU block may refer to a basic unit of frequency that may be allocated to an AP. For the sake of illustration, different colors are represented as unique patterns and color gradient is conveyed by varying degrees of shading within these patterns.

The first time-frequency graph 502 may represent an aggregate TXOP schedule of first through third APs and the second time-frequency graph 504 may represent a TXOP schedule of a fourth AP. In the first time-frequency graph 502, cells having a first pattern represent a first proportion of RUs allocated to the first AP, cells having a second pattern represent a second proportion of RUs allocated to the second AP, and cells having a third pattern represent a third proportion of RUs allocated to the third AP.

At times, an MAPC coordinator may receive the TXOP schedule from a new AP (e.g., the fourth AP) after the aggregate TXOP schedule is already generated. In the second time-frequency graph 504, RU requirements of the fourth AP are represented in a fourth pattern. A higher priority RU requirement is indicated by a darker shade of the fourth pattern.

Upon receiving the TXOP schedule from the fourth AP, the MAPC coordinator may assess if any conflict exists between the first time-frequency graph 502 and the second time-frequency graph 504. In many embodiments, a first set of cells having the second pattern may overlap with a second set of cells having the fourth pattern. This may indicate that a conflict exists between RU allocation to the second AP and RU requirements of the fourth AP.

In a number of embodiments, the second AP may be spatially apart from the fourth AP and may not interfere with transmission or reception of data packets by the fourth AP. Therefore, the same RUs can be allocated to the second AP and the fourth AP for the same time slot. For example, the MAPC coordinator can reuse the RUs (cells represented with the second pattern) allocated to the second AP and unused cells, but in a single pass algorithm the RUs allocated to the third AP (cells represented with the third pattern) are locked. The MAPC coordinator can also reorganize the RUs allocated to the first AP (cells represented with the first pattern) to minimize latency for time sensitive transmissions. By such reorganization, the MAPC coordinator may generate a new TXOP schedule represented in the third time-frequency graph 506, where the same RUs that were previously allocated to the second AP are now allocated to the fourth AP, with some changes to RU allocation of the first AP.

Although a specific embodiment for resource allocation by utilizing overlapping BSS coloring scheme suitable for carrying out the various steps, processes, methods, and operations described herein is discussed with respect to FIG. 5, any of a variety of systems and/or processes may be utilized in accordance with embodiments of the disclosure. For example, the resource allocation may be performed in the time and frequency domain such that transmission and reception operations performed by one AP may not interfere with transmission and reception operations of other APs in same network. The elements depicted in FIG. 5 may also be interchangeable with other elements of FIGS. 1-4 and 6-10 as required to realize a particularly desired embodiment.

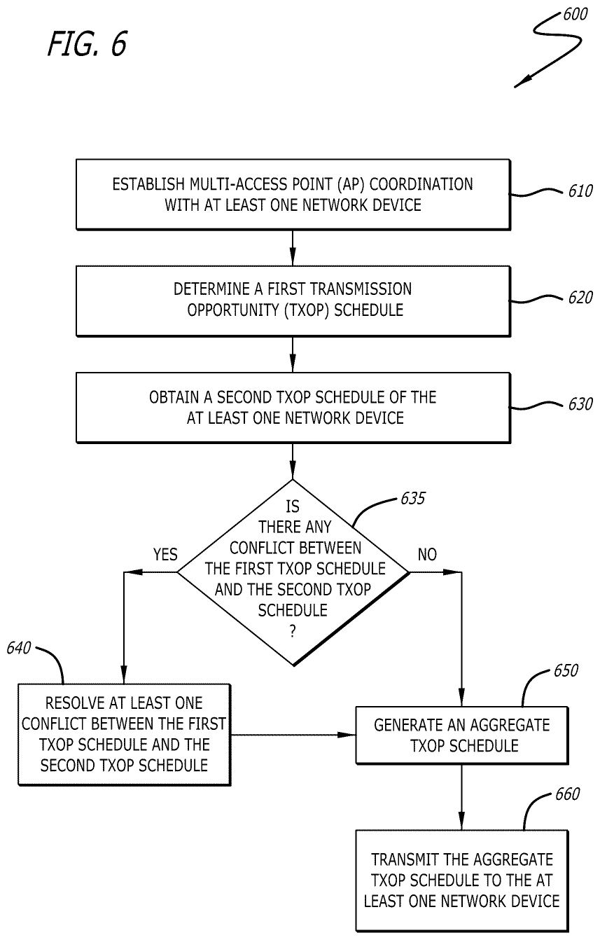

Referring to FIG. 6, a flowchart showing a process 600 for RU allocation in accordance with various embodiments of the disclosure is shown. In many embodiments, the process 600 may establish Multi-Access Point coordination (MAPC) with at least one network device (block 610). In numerous embodiments, to establish the MAPC between a first AP and a second AP (e.g., the at least one network device), the process 600 may broadcast a discovery message to identify the second AP. Upon receiving a response from the second AP, an MAPC coordinator (e.g., the first AP) may be selected for the MAPC set. The selection of the MAPC coordinator may be pre-configured or dynamic.

In a variety of embodiments, the process 600 may determine a first TXOP schedule (block 620). The first TXOP schedule may include connectivity requirements of a first plurality of devices associated with the first AP. In numerous additional embodiments, the first TXOP schedule may include a first set of RU requirements associated with the first AP. The first TXOP schedule may include a TXOP count, a transmission interval, a transmission duration, or an amount of traffic, associated with the first AP. Examples of the first TXOP schedule may include a downlink schedule, an uplink schedule, or a combination thereof. The uplink schedule may include a sequence, a routine, or pattern of data packets to be transmitted by the first AP. The downlink schedule may include a sequence, a routine, or a pattern of data packets to be received by the first AP. In several embodiments, the first TXOP schedule can be a variation of a buffer status report associated with the first AP.

In some embodiments, the process 600 may obtain a second TXOP schedule of the at least one network device (block 630). For example, the process 600 may receive the second TXOP schedule from the second AP. The second TXOP schedule may include a second set of RU requirements of the second AP. The second TXOP schedule may include a TXOP count, a transmission interval, a transmission duration, or an amount of traffic, associated with the second AP. In more embodiments, the second TXOP schedule may include an uplink schedule. The uplink schedule may include a sequence, a routine, or a pattern of data packets to be transmitted by the second AP. In more embodiments, the second TXOP schedule may include a downlink schedule. The downlink schedule may include a sequence, a routine, or a pattern of data packets to be received by the second AP.

In further embodiments, the process 600 may determine whether there is any conflict between the first TXOP schedule and the second TXOP schedule (block 635). In furthermore embodiments, a conflict in the first TXOP and the second TXOP may be caused because of overlapping connectivity requirements in the first and second set of RU requirements. These conflicts can occur if the simultaneous RU demands of the first and second APs exceed total available RUs that can be allocated to the first and second APs.

In still more embodiments, if there is a conflict between the first TXOP schedule and the second TXOP schedule, the process 600 may resolve the conflict between the first TXOP schedule and the second TXOP schedule (block 640). The process 600 may assign a weight to each RU requirement of the first and second TXOP schedules. The process 600 may resolve the conflict by assigning an RU to an RU requirement with a higher weight. In an example, the process may assign a weight each traffic identifier (TID) indicated in the first and second TXOP schedules, with the weight being determined proportionally based on a TID value and the amount traffic associated with corresponding TID. TID may refer to a unique identifier associated with each stream of traffic within the network.

In yet more embodiments, in response to the resolution of the conflict, the process 600 may generate an aggregate TXOP schedule (block 650). In still further embodiments, if there is no conflict between the first TXOP schedule and the second TXOP schedule, the process 600 may generate an aggregate TXOP schedule (block 650). The aggregate TXOP schedule may be generated such that it meets the connectivity requirements of the first AP and the second AP. The aggregate TXOP schedule may include a distribution of a set of RUs among the first and second APs. In other words, the aggregate TXOP schedule may include at least one TXOP that has a first proportion of RUs of the set of RUs allocated to the first AP and a second proportion of RUs of the set of RUs allocated to the second AP. The first proportion of RUs and the second proportion of RUs are distributed in the time and frequency domain. In still additional embodiments, the first TXOP schedule may include the first set of RU requirements represented in a first color and the second TXOP schedule may include the second set of RU requirements represented in a second color. Further, the aggregate TXOP schedule may include the first proportion of RU requirements represented in the first color and the second proportion of RU requirements represented in the second color. Such a representation of required and allocated RUs allows for an easy identification of resource requirements and allocated resources.

In further embodiments, the process 600 may transmit the aggregate TXOP schedule to the second AP (block 660). The second AP may accept the aggregate TXOP schedule in case the second proportion of RUs meet the second set of RU requirements. Subsequently, the first AP may distribute the first proportion of RUs among associated network devices. The second AP may distribute the second proportion of RUs among network devices associated therewith. In several additional embodiments, the process 600 may communicate a trigger frame to the second AP prior to the start of next TXOP. The communication of the trigger frame may act as a signal to the second AP to resend new TXOP schedule for the next period.

Although a specific embodiment for RU allocation among APs suitable for carrying out the various steps, processes, methods, and operations described herein is discussed with respect to FIG. 6, any of a variety of systems and/or processes may be utilized in accordance with embodiments of the disclosure. For example, in many further embodiments, both MAPC coordinator and secondary APs in an MAPC set can transmit aligned preambles. The elements depicted in FIG. 6 may also be interchangeable with other elements of FIGS. 1-5 and 7-10 as required to realize a particularly desired embodiment.

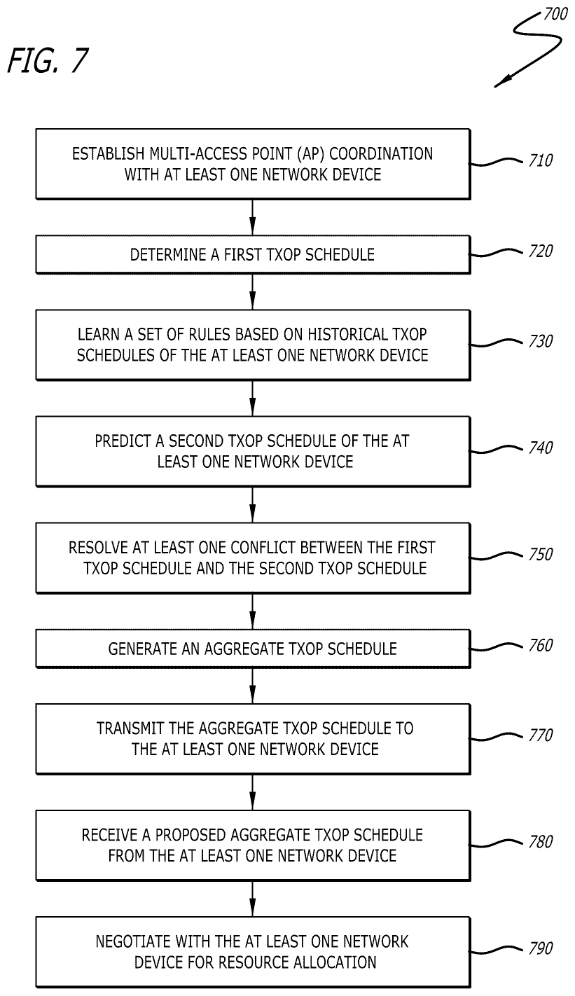

Referring to FIG. 7, a flowchart showing a process 700 for RU allocation in accordance with various embodiments of the disclosure is shown. In many embodiments, the process 700 may establish MAPC with at least one network device (block 710). In numerous embodiments, to establish the MAPC between a first AP and a second AP (e.g., the at least one network device), the process 700 may broadcast a discovery message to identify the second AP. Upon receiving a response from the second AP, an MAPC coordinator (e.g., the first Ap) may be selected for the MAPC set. The selection of the MAPC coordinator may be pre-configured or dynamic.

In a variety of embodiments, the process 700 may determine a first TXOP schedule (block 720). The first TXOP may include connectivity requirements of a first plurality of devices associated with the first AP. In numerous embodiments, the first TXOP schedule may include a first set of RU requirements associated with the first AP. The first TXOP schedule may include a TXOP count, a transmission interval, a transmission duration, or an amount of traffic, associated with the first AP. Examples of the first TXOP schedule may include a downlink schedule, an uplink schedule, or a combination thereof. The uplink schedule may include a sequence, a routine, or pattern of data packets to be transmitted by the first AP. The downlink schedule may include a sequence, a routine, or a pattern of data packets to be received by the first AP.

In several embodiments, the first TXOP schedule can be a variation of a buffer status report associated with the first AP.

In more embodiments, the process 700 may learn a set of rules based on historical TXOP schedules of the at least one network device (namely, a second AP) (block 730). The set of rules may be learned by identifying one or more patterns in historical TXOP schedules received from the second AP. The historical TXOP schedules may be TXOP schedules received from the second AP in the past.

In additional embodiments, the process 700 may predict the second TXOP schedule of the second AP (block 740). The second TXOP schedule may be obtained by predicting connectivity requirements of the second AP. In such embodiments, the process 700 may predict the second TXOP schedule based on the set of rules. Examples of the second TXOP schedule may include a downlink schedule, an uplink schedule, or a combination thereof. The uplink schedule may include a sequence, a routine, or pattern of data packets to be transmitted by the second AP. The downlink schedule may include a sequence, a routine, or a pattern of data packets to be received by the second AP.

In still more embodiments, the process 700 may resolve at least one conflict between the first TXOP schedule and the second TXOP schedule (block 750). The conflicts in the first TXOP and the second TXOP may be caused because of overlapping connectivity requirements in the first and second sets of RU requirements. The overlapping connectivity requirement may be caused based on a simultaneous requirement of RUs that, collectively, may be more than a set of RUs that may be available to be allocated to the first and second APs. The process 700 may assign a weight to each RU requirement of the first and second TXOP schedules. The process 700 may resolve the conflict by assigning an RU to an RU requirement with a higher weight. In an example, the process may assign a weight each traffic identifier (TID) indicated in the first and second TXOP schedules, with the weight being determined proportionally based on a TID value and the amount traffic associated with corresponding TID. TID may refer to a unique identifier associated with each stream of traffic within the network.

In still further embodiments, based on the resolution of the conflict, the process 700 may generate an aggregate TXOP schedule (block 760). The aggregate TXOP schedule may be generated such that it meets the connectivity requirements of the first AP and the second AP. The aggregate TXOP schedule may include a distribution of a set of RUs among the first and second APs. In other words, the aggregate TXOP schedule may include at least one TXOP that has a first proportion of RUs of the set of RUs allocated to the first AP and a second proportion of RUs of the set of RUs allocated to the second AP. The first proportion of RUs and the second proportion of RUs are distributed in the time and frequency domain. The first proportion of RUs and the second proportion of RUs, collectively, form the set of RUs.

In still additional embodiments, the process 700 may transmit the aggregate TXOP schedule to the second AP (block 770). Subsequently, the process 700 may receive a proposed aggregate TXOP from the second AP (block 780). When the aggregate TXOP schedule does not meet the second set of RU requirements, the second AP may generate the proposed aggregate TXOP schedule. The proposed aggregate TXOP schedule may be generated as an alternative to the aggregate TXOP schedule. The proposed aggregate TXOP schedule may include a third proportion of RUs as a replacement to the second proportion of RUs. The third proportion of RUs may be different from the second proportion of RUs.

In some more embodiments, the process 700 may negotiate with the second AP for resource allocation (block 790). The process 700 may negotiate with the second AP by making one or more modifications in the allocation of RUs in the proposed aggregate TXOP schedule. The process 700 may communicate the modified proposed aggregate TXOP schedule to the second AP. Based on acceptance of the modified proposed aggregation TXOP schedule by the second AP, the first AP may distribute the fourth proportion of RUs among associated network devices and the second AP may distribute the third proportion of RUs among network devices associated therewith. In several additional embodiments, the process 700 may communicate a trigger frame to the second AP prior to the start of next TXOP. The communication of the trigger frame may act as a signal to the second AP to resend new TXOP schedule for the next period.

Although a specific embodiment for RU allocation among APs for carrying out the various steps, processes, methods, and operations described herein is discussed with respect to FIG. 7, any of a variety of systems and/or processes may be utilized in accordance with embodiments of the disclosure. For example, in still further embodiments, though the second TXOP schedule can be predicted using one or more machine learning models, in a stochastic environment, the predicted second TXOP schedule can differ from the actual second TXOP schedule. These differences can be accommodated in the predicted TXOP schedule of the subsequent period. The elements depicted in FIG. 7 may also be interchangeable with other elements of FIGS. 1-6 and 8-10 as required to realize a particularly desired embodiment.

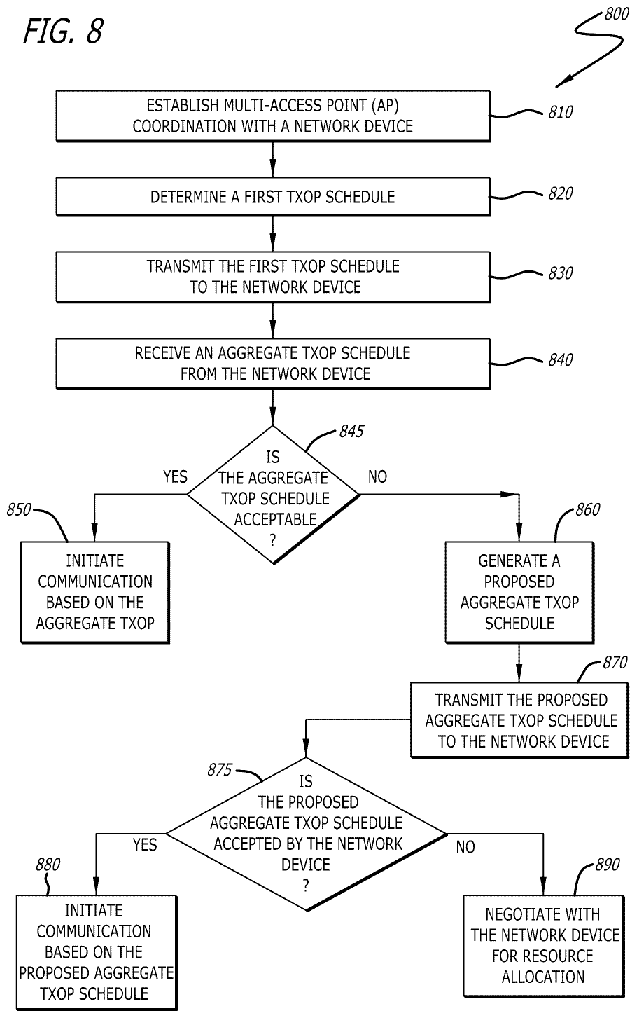

Referring to FIG. 8, a flowchart showing a process 800 for obtaining RU allocation in accordance with various embodiments of the disclosure is shown. In many embodiments, the process 800 may establish MAPC with at least one network device (block 810). In numerous embodiments, to establish the MAPC between a first AP and a second AP (e.g., the at least one network device), the process 800 may broadcast a discovery message, which is received by the second AP. Once the first AP and the second AP discover each other and an MAPC set is formed, an MAPC coordinator (e.g., the second AP) may be selected for the MAPC set. The selection of the MAPC coordinator may be pre-configured or dynamic.

In a variety of embodiments, the process 800 may determine a first TXOP schedule (block 820). The first TXOP schedule may include connectivity requirements of a first plurality of devices associated with the first AP. In numerous additional embodiments, the first TXOP schedule may include a first set of RU requirements associated with the first AP. The first TXOP schedule may include a TXOP count, a transmission interval, a transmission duration, or an amount of traffic, associated with the first AP. Examples of the first TXOP schedule may include a downlink schedule, an uplink schedule, or a combination thereof. The uplink schedule may include a sequence, a routine, or pattern of data packets to be transmitted by the first AP. The downlink schedule may include a sequence, a routine, or a pattern of data packets to be received by the first AP.

In a number of embodiments, the process 800 may transmit the first TXOP schedule to the second AP (block 830). In several embodiments, the second AP may be the designated coordinator for MAPC and may have a second TXOP schedule. In more embodiments, the process 800 may receive an aggregate TXOP schedule from the second AP (block 840). In several additional embodiments, the aggregate TXOP schedule may be generated based on the first TXOP schedule and the second TXOP schedule. In various embodiments, the aggregate TXOP schedule may include allocation of RUs to the first AP and the second AP. For example, the aggregate TXOP schedule may include at least one TXOP that has a first proportion of RUs allocated to the first AP and a second proportion of RUs allocated to the second AP. The aggregate TXOP schedule may include allocation of RUs in the time and frequency domain.

In additional embodiments, the process 800 may determine whether the aggregate TXOP schedule is acceptable. For example, in the aggregate TXOP schedule, one or more RU requirements of the first AP may not be met. As a result, the aggregate TXOP schedule may not be acceptable to the process 800. However, if the aggregate TXOP schedule meets the first set of RU requirements, or at least all high priority RU requirements of the first AP, the aggregate TXOP schedule may be acceptable to the process 800.

In still additional embodiments, if the aggregate TXOP schedule is acceptable, the process 800 may initiate communication based on the aggregate TXOP (block 850). The first AP and the second AP may initiate transmission and reception of corresponding data packets and frames by using the allocated RUs at designated time slots.

In further additional embodiments, if the aggregate TXOP schedule is not acceptable, the process 800 may generate a proposed TXOP schedule (block 860). The proposed aggregate TXOP schedule may be generated as an alternative to the aggregate TXOP schedule. The proposed aggregate TXOP schedule may include a third proportion of RUs as a replacement to the first proportion of RUs. The third proportion of RUs may be different from the first proportion of RUs. In still more embodiments, the process 800 may transmit the proposed aggregate TXOP schedule to the network device (block 870). In many examples, the network device is the second AP, e.g., the designated coordinator for MAPC.

In still further embodiments, the process 800 may determine whether the proposed aggregate TXOP schedule is accepted by the network device (block 875). For example, if the the proposed aggregate TXOP schedule is accepted by the second AP, the first AP may receive an acceptance notification from the second AP. However, if the proposed aggregate TXOP schedule is not accepted by the second AP, the first AP may receive a rejection notification from the second AP.

In yet more embodiments, if the proposed aggregate TXOP schedule is accepted by the network device, the process 800 may initiate communication based on the proposed aggregate TXOP (block 880). The first AP and the second AP may initiate transmission and reception of corresponding data packets and frames by using the allocated RUs at designated time slots in the proposed aggregate TXOP.

In still yet more embodiments, if the proposed aggregate TXOP schedule is not accepted by the network device, the process 800 may negotiate with the network device for resource allocation (block 890). For example, during negotiation, the first AP may receive a modified proposed aggregate TXOP schedule from the second AP. The process 800 can either accept the modified aggregate TXOP schedule or propose further modification. The negotiation process may continue until the first AP and the second AP reach a consensus on the resource allocation.

Although a specific embodiment for RU allocation among APs for carrying out the various steps, processes, methods, and operations described herein is discussed with respect to FIG. 8, any of a variety of systems and/or processes may be utilized in accordance with embodiments of the disclosure. For example, in further embodiments, the first AP may predict whether a requested RU in the transmitted TXOP schedule will be granted, moved, or denied by the MAPC coordinator and accordingly may request those RUs that satisfy the communication requirements and also have a high likelihood of grant by the MAPC coordinator. Further, the first AP may align low priority communication requirements with those RUs that have low likelihood of grant by the MAPC coordinator. The elements depicted in FIG. 8 may also be interchangeable with other elements of FIGS. 1-7, 9, and 10 as required to realize a particularly desired embodiment.

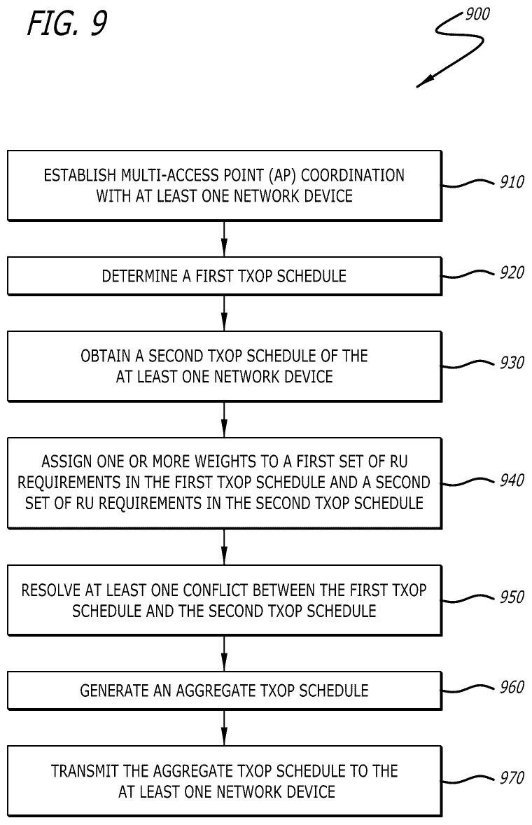

Referring to FIG. 9, a flowchart showing a process 900 for RU allocation in accordance with various embodiments of the disclosure is shown. In many embodiments, the process 900 may establish MAPC with at least one network device (block 910). In numerous embodiments, to establish the MAPC between a first AP and a second AP (e.g., the at least one network device), the process 900 may broadcast a discovery message to identify the second AP. Upon receiving a response from the second AP, an MAPC coordinator (e.g., the first Ap) may be selected for the MAPC set. The selection of the MAPC coordinator may be pre-configured or dynamic.

In a variety of embodiments, the process 900 may determine a first TXOP schedule (block 920). The first TXOP may include connectivity requirements of a first plurality of devices associated with the first AP. In numerous embodiments, the first TXOP schedule may include a first set of RU requirements associated with the first AP. The first TXOP schedule may include a TXOP count, a transmission interval, a transmission duration, or an amount of traffic, associated with the first AP. Examples of the first TXOP schedule may include a downlink schedule, an uplink schedule, or a combination thereof. The uplink schedule may include a sequence, a routine, or pattern of data packets to be transmitted by the first AP. The downlink schedule may include a sequence, a routine, or a pattern of data packets to be received by the first AP.

In several embodiments, the first TXOP schedule can be a variation of a buffer status report associated with the first AP.

In more embodiments, the process 900 may obtain a second TXOP schedule of the at least one network device (block 930). For example, the process 900 may receive the second TXOP schedule from the second AP. The second TXOP schedule may include a second set of RU requirements of the second AP. The second TXOP schedule may include a TXOP count, a transmission interval, a transmission duration, or an amount of traffic, associated with the second AP.

In more embodiments, the second TXOP schedule may include an uplink schedule. The uplink schedule may include a sequence, a routine, or a pattern of data packets to be transmitted by the second AP. In more embodiments, the second TXOP schedule may include a downlink schedule. The downlink schedule may include a sequence, a routine, or a pattern of data packets to be received by the second AP.

In additional embodiments, the process 900 may assign one or more weights to each RU requirement of the first and second TXOP schedules (block 940). An RU requirement with a high priority may be assigned a higher weight. In an example, the process may assign a weight each traffic identifier (TID) indicated in the first and second TXOP schedules, with the weight being determined proportionally based on a TID value and the amount traffic associated with corresponding TID. TID may refer to a unique identifier associated with each stream of traffic within the network.

In further embodiments, the process 900 may resolve at least one conflict between the first TXOP schedule and the second TXOP schedule (block 950). The conflicts in the first TXOP and the second TXOP may be caused because of overlapping connectivity requirements in the first and second set of RU requirements. The overlapping connectivity requirement may be caused based on a simultaneous requirement of RUs that, collectively, may be more than a set of RUs that may be available to be allocated to the first and second APs. The process 900 may resolve the conflict between the first TXOP schedule and the second TXOP schedule by assigning an RU to an RU requirement with a higher weight. In other words, the process 900 may resolve the conflict between two RU requirements by assigning RU to an RU requirement with a higher weight.

In still further embodiments, based on the resolution of the conflict, the process 900 may generate an aggregate TXOP schedule (block 960). The aggregate TXOP schedule may be generated such that it meets the connectivity requirements of the first AP and the second AP. The aggregate TXOP schedule may include a distribution of a set of RUs among the first and second APs. In other words, the aggregate TXOP schedule may include a first proportion of RUs of the set of RUs allocated to the first AP and a second proportion of RUs of the set of RUs allocated to the second AP. The first proportion of RUs and the second proportion of RUs are distributed in the time and frequency domain. The first proportion of RUs and the second proportion of RUs, collectively, form the set of RUs.

In still additional embodiments, the process 900 may transmit the aggregate TXOP schedule to the second AP (block 970). The second AP may accept the aggregate TXOP schedule in case the second proportion of RUs meet the second set of RU requirements. Subsequently, the first AP may distribute the first proportion of RUs among associated network devices. The second AP may distribute the second proportion of RUs among network devices associated therewith. Subsequently, the network devices associated with the first AP and the second AP may initiate communication of data packets and frames. In several additional embodiments, the process 900 may communicate a trigger frame to the second AP prior to the start of next TXOP. The communication of the trigger frame may act as a signal to the second AP to resend new TXOP schedule for the next period.

Although a specific embodiment for RU allocation among APs for carrying out the various steps, processes, methods, and operations described herein is discussed with respect to FIG. 9, any of a variety of systems and/or processes may be utilized in accordance with embodiments of the disclosure. For example, in some more embodiments, the second TXOP schedule transmitted by the second AP may include weights associated with each RU requirement. Such weights may be indicative of a priority sequence in which the second AP may prefer to get its RU requirements fulfilled. The elements depicted in FIG. 9 may also be interchangeable with other elements of FIGS. 1-8 and 10 as required to realize a particularly desired embodiment.

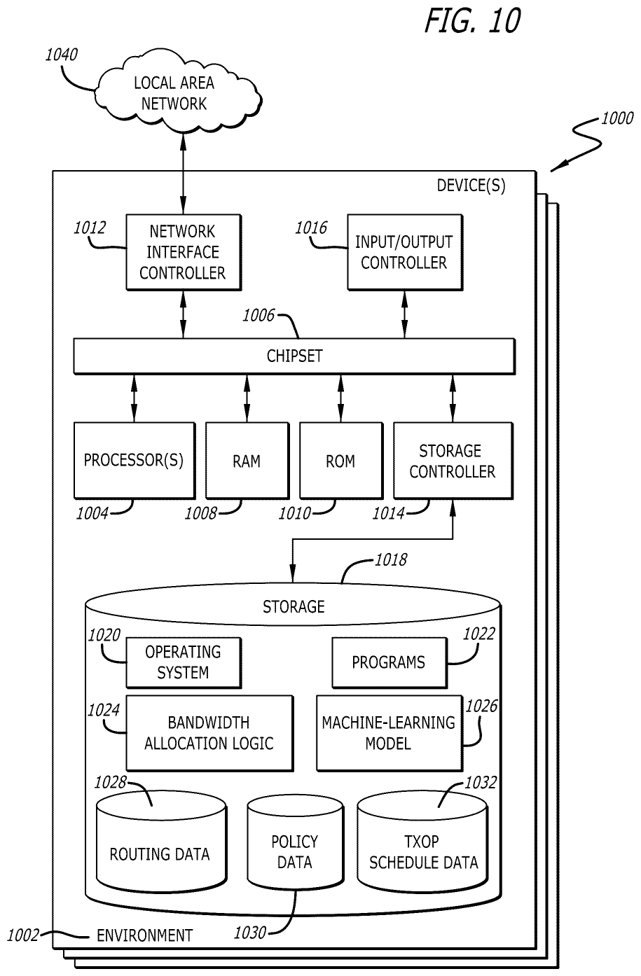

Referring to FIG. 10, a conceptual block diagram of a device 1000 suitable for configuration with a power management logic, in accordance with various embodiments of the disclosure is shown. The embodiment of the conceptual block diagram depicted in FIG. 10 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many nonlimiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022, routing data 1028, policy data 1030, and TXOP schedule data 1032 which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of the physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In certain embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform the functions described herein. The virtualization layer may generally support a virtual resource that performs at least a portion of the techniques described herein.

In many further embodiments, the device 1000 may include a bandwidth allocation logic 1024. The bandwidth allocation logic 1024 can be configured to perform one or more of the various steps, processes, operations, and/or other methods that are described above. Often, the bandwidth allocation logic 1024 can be a set of instructions stored within a non-volatile memory that, when executed by the processor(s)/controller(s) 1004 can carry out these steps, etc. In certain embodiments, the bandwidth allocation logic 1024 may perform various operations related to resource allocation among a plurality of APs. The bandwidth allocation logic 1024 may be configured to generate a first TXOP schedule, transmit the first TXOP schedule, receive a second TXOP schedule, resolve conflict among the first and second TXOP schedules, and generate an aggregate TXOP schedule based on the first and second TXOP schedules. The bandwidth allocation logic 1024 may be further configured to transmit the aggregate TXOP to each AP for which the aggregate TXOP schedule include a proportion of allocated RUs.

In a number of embodiments, the storage 1018 can include routing data 1028. In additional embodiments, the routing data 1028 can include information, for example, routing tables. Routing table may contain various entries that map destination IP addresses to next hop or outgoing ports. Routing tables may enable the device 1000 in making packet forwarding decisions. MAC address table is an example of a routing table. MAC address table may include destination MAC addresses mapped to corresponding switch ports. The routing data 1028 may further store a mapping between IP addresses and MAC addresses within a network. Such mapping may be utilized to translate IP addresses to MAC addresses for proper forwarding of packets.

In various embodiments, the storage 1018 can include policy data 1030. In several embodiments, the policy data 1030 can comprise information regarding access control lists. Access control lists may delineate a set of rules that determine what type of traffic is allowed or denied on the network. The set of rules can be based on various criteria such as source or destination IP addresses, port numbers, or communication protocols. In several more embodiments, the policy data 1030 can include QoS policies. For example, QoS policies can be used to prioritize certain types of traffic (e.g., encoding objects and error response packets) over others to ensure that critical applications receive required latency requirements. In numerous additional embodiments, the policy data 1030 can further include security policies, authentication and authorization policies, or the like.

In a number of embodiments, the storage 1018 can include TXOP schedule data 1032. The TXOP schedule data 1032 may store TXOP schedules associated with the device 1000. Further, the TXOP schedule data 1032 may indicate TXOP schedules generated or received in the past. Thus, by referring to the TXOP schedule data 1032, the bandwidth allocation logic 1024 may determine how RUs were allocated in the past. The TXOP schedule data 1032 may also include the proposed aggregate schedule data received by the device 1000. A proposed aggregate schedule data when accessed by the bandwidth allocation logic 1024 may indicate RU allocation preferred by an associated AP.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more linear regression models, logistic regression models, decision trees, Naïve Bayes models, neural networks, k-means cluster models, random forest models, and/or other types of ML models 1026.

The ML model(s) 1026 can be configured to generate inferences to make predictions or draw conclusions from data. An inference can be considered the output of a process of applying a model to new data. This can occur by learning from at least the routing data 1028, the policy data 1030, and the TXOP schedule data 1032, and utilize the learning to predict future outcomes. For example, the ML model(s) 1026 can be trained to predict TXOP schedules. The ML model(s) 1026 may be configured to learn patterns of RU requirements in historical TXOP schedules received by the device 1000. Based on the learned patterns, the ML model(s) 1026 may be configured to derive a set of rules associated with the RU requirements. Based on the set of rules, the ML model(s) 1026 may be configured to predict TXOP schedules for a current TXOP or a future TXOP. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for a device suitable for configuration with a dynamic proxying logic for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although a specific embodiment for a conceptual block diagram of the device 1000 suitable for configuration with the power management logic suitable for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises a bandwidth allocation logic that is configured to:
determine a first transmission opportunity (TXOP) schedule of the device;
obtain a second TXOP schedule of at least one network device;
generate an aggregate TXOP schedule based on the first TXOP schedule and the second TXOP schedule, wherein the aggregate TXOP schedule comprises at least one TXOP that has a first proportion of resource units (RUs) allocated to the device and a second proportion of RUs allocated to the at least one network device; and
transmit the aggregate TXOP schedule to the at least one network device.

2. The device of claim 1, wherein the bandwidth allocation logic is further configured to resolve at least one conflict between the first TXOP schedule and the second TXOP schedule.

3. The device of claim 2, wherein the aggregate TXOP schedule is generated in response to resolving the at least one conflict between the first TXOP schedule and the second TXOP schedule.

4. The device of claim 2, wherein the at least one conflict is caused by one or more overlapping RU requirements in the first TXOP schedule and the second TXOP schedule.

5. The device of claim 1, wherein obtaining the second TXOP schedule comprises receiving the second TXOP schedule from the at least one network device.

6. The device of claim 1, wherein obtaining the second TXOP schedule comprises predicting the second TXOP based on a set of rules.

7. The device of claim 6, wherein the bandwidth allocation logic is further configured to learn the set of rules based on one or more historical TXOP schedules of the at least one network device.

8. The device of claim 1, wherein the second TXOP schedule comprises at least one of an uplink schedule or a downlink schedule.

9. The device of claim 1, wherein the second TXOP schedule comprises at least one of: a TXOP count, a transmission interval, a transmission duration, or an amount of traffic.

10. The device of claim 1, wherein in response to transmitting the aggregate TXOP schedule, the bandwidth allocation logic is further configured to receive a proposed aggregate TXOP schedule from the at least one network device.

11. The device of claim 10, wherein the proposed aggregate TXOP schedule comprises at least a third proportion of RUs allocated to the at least one network device that is different from the second proportion of RUs.

12. The device of claim 1, wherein the first proportion of RUs and the second proportion of RUs are distributed in a time and frequency domain.

13. The device of claim 1, wherein the first TXOP schedule comprises a first set of RU requirements associated with the device and the second TXOP schedule comprises a second set of RU requirements associated with the at least one network device.

14. The device of claim 13, wherein the first set of RU requirements is represented in a first color in the first TXOP schedule and the second set of RU requirements is represented in a second color in the second TXOP schedule.

15. The device of claim 14, wherein to generate the aggregate TXOP schedule, the bandwidth allocation logic is further configured to:
assign one or more weights to the first set of RU requirements and the second set of RU requirements; and
resolve at least one conflict between the first TXOP schedule and the second TXOP schedule based on the one or more weights, wherein the aggregate TXOP schedule is generated in response to resolving the at least one conflict.

16. The device of claim 15, wherein the aggregate TXOP schedule comprises the first proportion of RUs represented in the first color and the second proportion of RUs represented in the second color.

17. The device of claim 1, wherein prior to generating the aggregate TXOP schedule, the bandwidth allocation logic is further configured to establish Multi-Access Point (AP) coordination between the device and the at least one network device.

18. The device of claim 1, wherein the second TXOP schedule is associated with a set of network devices coordinated by the at least one network device.

19. A device, comprising:
a processor;
a network interface controller configured to provide access to a network; and
a memory communicatively coupled to the processor, wherein the memory comprises a bandwidth allocation logic that is configured to:
transmit a first TXOP schedule to a network device, wherein the network device is a designated coordinator for Multi-Access Point (AP) coordination and has a second TXOP schedule; and
receive an aggregate TXOP schedule based on the first TXOP schedule and the second TXOP schedule, wherein the aggregate TXOP schedule comprises at least one TXOP that has a first proportion of resource units (RUS) allocated to the device and a second proportion of RUs allocated to the network device.

20. A method, comprising:
determining a first transmission opportunity (TXOP) schedule of a first network device;
obtaining a second TXOP schedule of a second network device;
generating an aggregate TXOP schedule based on the first TXOP schedule and the second TXOP schedule, wherein the aggregate TXOP schedule comprises at least one TXOP that has a first proportion of resource units (RUs) allocated to the first network device and a second proportion of RUs allocated to the second network device; and
transmitting the aggregate TXOP schedule to the second network device.
